(19) United States
(12) Patent Application Publication
(10) Pub. No.: US 2015/0107676 A1
(43) Pub. Date: Apr. 23, 2015

(54) System and Method for Automatically Actuating A Valve

(71) Applicants: Jesse J. Green, Ratcliff, AR (US); Brad Andrews, Tumbling Shoals, AR (US)

(72) Inventors: Jesse J. Green, Ratcliff, AR (US); Brad Andrews, Tumbling Shoals, AR (US)

(21) Appl. No.: 14/473,587

(22) Filed: Aug. 29, 2014

Related U.S. Application Data
(60) Provisional application No. 61/892,934, filed on Oct. 18, 2013.

(51) Int. Cl. G05D 9/12; G05B 15/02; G05D 7/06

(52) U.S. Cl. CPC G05D 9/12; G05D 7/0635; G05B 15/02
USPC 137/2; 137/397; 137/389; 700/282

(57) ABSTRACT

A system and methods for automatically actuating a valve are provided herein. The method includes energizing sensors, a controller and an actuator with power that is generated locally at the site of the valve.

### CROSS REFERENCE TO RELATED APPLICATIONS

This application claims the priority benefit of U.S. patent application 61/892,934 filed Oct. 18, 2013 entitled SYSTEM AND METHOD FOR AUTOMATICALLY ACTUATING A VALVE, the entirety of which is incorporated by reference herein.

### FIELD OF THE INVENTION

Exemplary embodiments of the present techniques relate to automatically actuating a valve using power that is generated locally at the site of the valve.

### BACKGROUND

This section is intended to introduce various aspects of the art, which may be associated with exemplary embodiments of the present techniques. This description is believed to assist in providing a framework to facilitate a better understanding of particular aspects of the present techniques. Accordingly, it should be understood that this section should be read in this light, and not necessarily as admissions of prior art.

The mechanical oil valve is a commonly used valve designed to release separated fluids out of a hydrocarbon stream into a production vessel. Mechanical oil valves are float operated liquid-level control valves connected to a separator vessel. As the fluid level inside the vessel rises, the float and rod assembly mounted inside the vessel also rises. Through a mechanical linkage, the rising float actuates the mechanical oil valve open enough to maintain a level in the separator vessel. In some applications, when the vessel is separating fluid at a very slow rate, e.g., less than about 20 barrels per day, a trickle effect takes place. This occurs when the mechanical oil valve opens enough to merely maintain the level in the separator vessel. Attempting to measure the fluid passing by the mechanical oil valve becomes extremely difficult after such a trickle effect has started.

The traditional method for obtaining this action was to install a pneumatically actuated valve or an electrically actuated valve. For a pneumatically actuated valve, a supply gas must be provided either through a compression system bottled gas or produced gas (methane) from the facility. Air compression systems are expensive and require a large power supply on a location, either a methane powered engine or larger electric power supply. Bottled gas is expensive and labor intensive to maintain. Methane emissions are closely regulated by state and federal government agencies. For example, the Environmental Protection Agency produced a document encouraging producers and operators to reduce the number of methane operated valves in the field. Electrically actuated valves require a larger powers supply to be on location and are expensive. Both of these options require that an existing mechanically operated valve be replaced and a piping change made to accommodate a new valve. This provides the need for a device to control the valve based on the set point level to open the dump completely, and then close the dump completely based on a low level set point without changing the valve.

In order to measure low fluid flow rates utilizing devices such as turbine meters, magnetic flow meters, or orifice meters, among others, a very small pipe size or orifice size is needed. If the fluid volume in the inlet hydrocarbon fluid stream increases drastically in a short period of time, then the small pipe size severely restricts drainage flow and the separator fills with fluid. Further, the fluid may contain particulates, such as sand, iron sulfide fines, and the like, which can easily build up and completely block flow through the small pipe or orifice, causing the separator to fill up with fluid. These issues provide the need to for a device to completely open the valve based on a high level set point indication, and then completely close the dump valve when on a low level set point is reached.

### SUMMARY

An exemplary embodiment provides a system for automatically actuating a valve. The system incorporates use of a local source of power generation, such as a solar panel, to energize the components of the embodiment which require electricity to operate. That is, the power that is generated locally will be used to power at least the sensors, the controller and the actuator of the current system.

Another exemplary embodiment provides a method for automatically actuating a valve in a tank storage system. The method includes monitoring the interface level within a vessel or tank, and making a determination whether the interface level has reached the high level set point. The method also includes actuating completely open a dump valve, and activating a timed delay latching block sequence. The dump valve will remain open until an indication that the interface level has reached the low level set point, or an indication that the latching block sequence has timed out. At either indication, the method then provides to actuate the valve closed, and to again monitor the interface level within the vessel.

Another exemplary embodiment provides a non-transitory, computer-readable medium used to configure a processor to perform the techniques described herein. The nontransitory, computer-readable medium includes code configuring a processor to detect signals from sensors and direct an actuator to actuate completely open or actuate closed a valve upon the detection of specific signals.

### BRIEF DESCRIPTION OF THE DRAWINGS

The advantages of the present techniques are better understood by referring to the following detailed description and the attached drawings, in which:

FIG. 1 is an illustration of a locally powered controller, sensor and actuator system that can be installed on existing valves;

FIG. 2 is a schematic of an actuator system that is automatically controlled and powered by a local power generation system;

FIG. 3 is a schematic of the controller logic sequence that controls commands sent by the controller based on the input signals received;

FIG. 4 is a process flow diagram of a method for monitoring an interface level and automatically actuating a valve completely open or closed; and

FIG. 5 is another schematic of an actuator system that is automatically controlled and powered locally by a wind turbine.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

If the fluid volume in an inlet fluid stream significantly increases in a short period of time, then drainage flow needs to be sufficiently maintained, or a separator vessel can overfill with fluid. The fluid, for example a production hydrocarbon fluid, may contain particulates, such as sand, iron sulfide fines, and the like, which can build up and completely block flow through a drainage pipe or orifice, especially in smaller sized pipes, causing the separator vessel to fill up with fluid. Another common problem is the buildup of particulate such as iron sulfide, sand, carbon, etc. on the internal seats of the valve itself Over time, this buildup can cause the valve to leak gas by the valve. The problem can then be exacerbated by the continual flow eroding or “cutting” the valve seats. In preliminary tests, 5-50 thousand cubic feet per day rate can leak by the valve as a result of this buildup. This problem will continue to get worse over time with continual buildup. These issues provide the need to for a device to completely open the vessel's dump valve based on a high level set point indication, and then fully close the dump valve when a low level set point is reached. Such a method and system helps ensure the separator vessel maintains a fluid level that is within certain defined parameters. Using techniques described herein, a valve is actuated completely open so that fluid in a vessel will drain in amounts that are readily quantifiable. Further, the valve may be closed after a set amount of time, which may prevent the valve from hanging open.

One embodiment may consist of four parts: power supply, level detection, logic controller, and actuator bracket. The fluid level inside the vessel may be detected in two designated set points. When the fluid level is high, the actuator opens the valve. When the level reaches a designated low point in the vessel, the actuator closes the valve.

Power Supply: The power supply may consist of a Battery, Solar Photo Voltaic array and a voltage regulator. The Direct Current Voltage may be supplied from the Photo Voltaic cell. It may be regulated to the designed battery voltage level by the regulator. The battery may store the electric energy until it is used by the actuator and the logic controller.

Fluid Detection: Detecting the fluid level inside the vessel can employ many different means. For example, ultrasonic point level devices can be installed either into the side of the vessel or in an external chamber mounted to the vessel. These detect a frequency change when the medium (gas vs. fluid) changes. The detector then sends a digital signal to the logic controller. Similarly, continuous level detection can be used by installing a continuous level monitoring device inside the vessel or in an external chamber connected to the vessel. It will provide a variable output signal to the logic controller depending on the level in the vessel. In one embodiment, a bracket is extended up to facilitate attaching two magnetic limit switches to it. The existing Float and Rod assembly may be used to detect fluid level and actuate the valve. As the fluid level in the vessel moves up, the external arm moves down. When the arm is in the sensing area of the limit switch, a set of contacts closes, sending the signal to the Logic controller to open the valve. The converse may happen as the vessel empties. Mechanical limit switches can also be used in this manner.

Logic Controller: The Logic controller can employ a Boolean logic program in a PLC (programmable logic controller) so that when a high level is detected it waits a few seconds before closing two relay contacts (A,B) to send current to the motor to open the valve. Contacts (A,B) will stay closed until they are opened by the low level detection. When the low level is detected, it opens contacts (A,B) and the two other relay contacts (C,D) close to send current to the motor. Contacts (C,D) will stay in this position until they are opened by high level detection. Reversing the polarity on the motor (+−,−+) may reverse the direction of movement. The tinier motor has built in limit switches so when the valve is fully open or fully closed the circuit is opened; therefore, no power is being used except during actuation. A timer is employed before each closure of contact to ensure that the output leads are not shorted. A variable tinier is also used so that when the valve is opened it can only stay open for a set amount of time (user can select this time) before it will force the valve to close. This is a safety feature that may prevent the valve from hanging open. As will be understood by those of skill in the art, use of integrated circuit chips (ICs) or a microprocessor can be used to perform this portion. This is a dedicated control board with logic gates or a basic level programming language performing the closing of the contacts and reversing polarity on the linier motor.

Actuator Bracket: The bracket may comprise an offset Y form when looking from the top. The bolt holes may be machined to fit the existing bolt holes in the top of the valve body. It may have a long top portion that extends upward to mount to the sensing switches. This part may be slotted so that the limit switches can be moved up or down to adjust the set point for actuation. The lower portion of the bracket may be slotted up and down to provide for adjustment of the L bracket that holds the motor. The L bracket may attach to the slotted holes in the lower portion of the main bracket. The tinier motor may be mounted to the L bracket by a small piece that has a threaded rod on one end and a U shaped top that allows a pin to slide into the mounting hole of the motor. The top of the motor may be attached to an existing actuating arm of the valve by a pin with bushings.

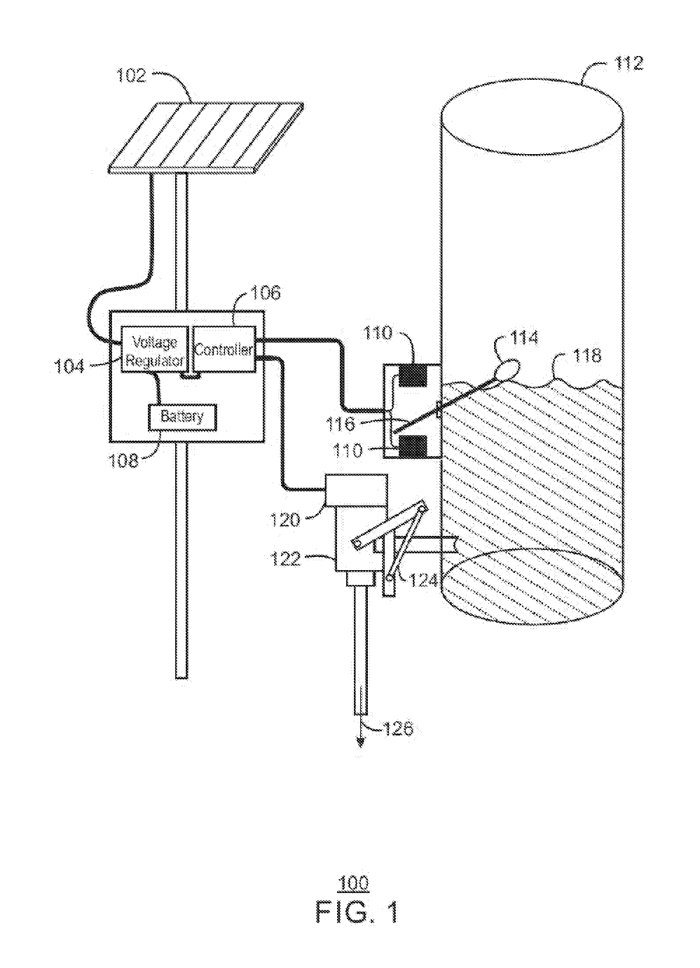

FIG. 1 is an illustration of a separation system that can be powered through locally generated electricity, and can be installed on existing valves. An exemplary embodiment of the system and techniques described herein incorporates a local power generation system, for example, photovoltaic panels 102. The photovoltaic panels 102 can be connected to a voltage regulator 104 that can be connected to a battery 108 to store the power received from the photovoltaic panels 102. The voltage regulator 104 can be used to provide power from the battery 108 or the photovoltaic panels 102 to power a controller 106, sensors 110, and an actuator 120. The controller 106 receives signals from sensors 110, for example, mounted on a vessel 112. A float 114 and rod assembly 116 can be mounted inside the vessel 112 to track an interface level 118 within the vessel 112. The interface level as used herein refers to a surface of separate fluid regions having contrasting flow and density properties. The interface level is intended to include fluid interfaces in an otherwise homogeneous medium, for example, the interface level between a water phase and an oil phase in a vessel 112.

As the float 114 rises, the outer arm of the rod assembly 116 moves downward, and vice-versa. The sensors 110, which are placed above and below the rod assembly 116, are used to determine the interface level 118 within the vessel 112. The density of the float 114 can be selected to float on top of a water phase, while remaining below an oil phase, thereby giving an indication as to the oil-water interface level within the vessel 112. As the interface level 118 rises, the rod assembly 116 moves closer to the bottom sensor 110, and, at a high level setting, actuates the sensor 110. Similarly, when the interface level 118 falls, the rod assembly 116 moves closer and finally actuates the top sensor 110.

In an exemplary embodiment, the sensors 110 are magnetic sensors that are configured to send an electrical signal to the controller 106 when the rod assembly 116 approaches within a defined proximity of an individual sensor 110. Accordingly, when the float 114 rises to an upper position, the rod assembly 116 approaches within the detection limit of the bottom sensor 110, and this sensor 110 then signals the controller 106 of this event. Upon receipt of a signal from the bottom-oriented sensor 110, the controller 106 commands the actuator 120 to open the valve 122. In an exemplary embodiment, a valve bracket 124 is retrofitted onto an existing valve 122 to allow installation of the system described herein.

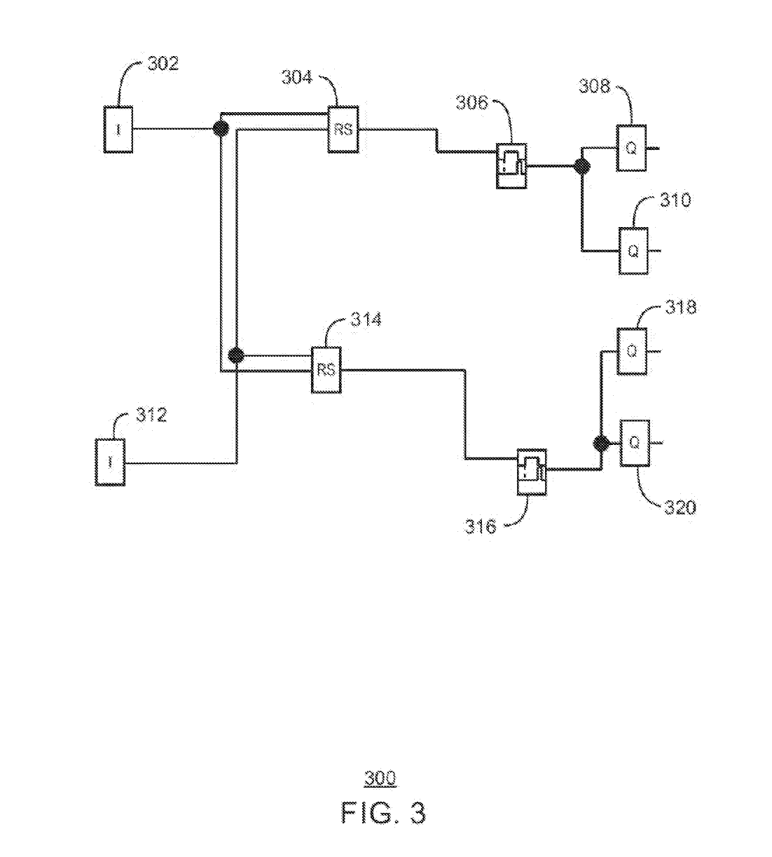

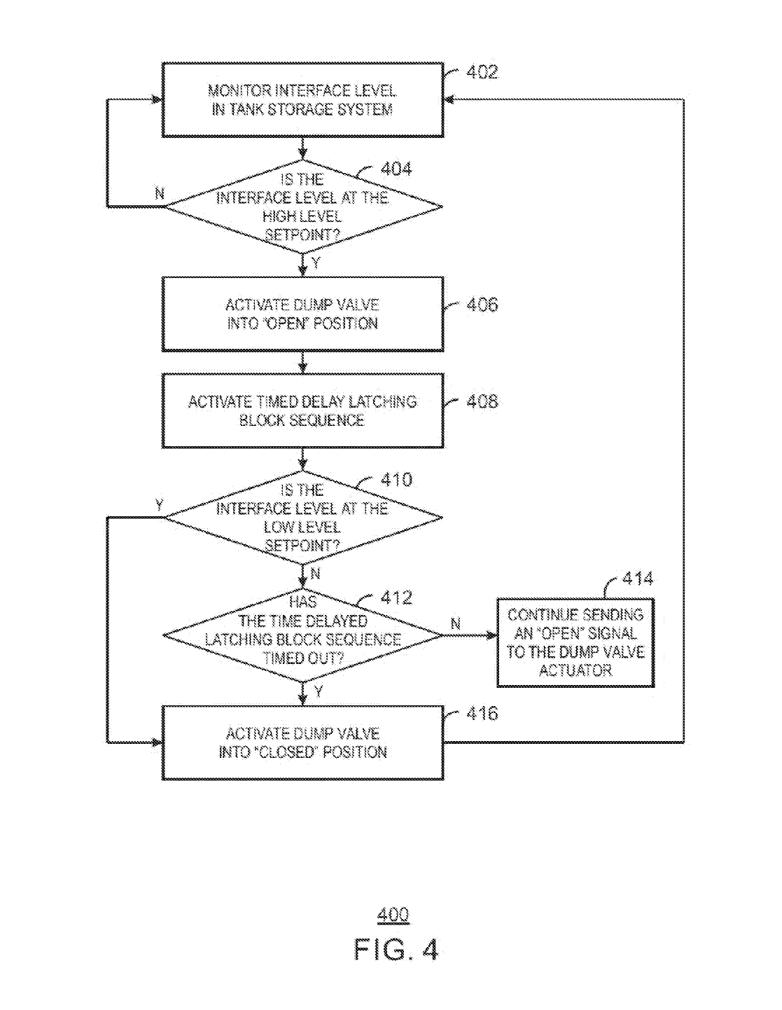

In further embodiments, the actuator 120 actuates the valve 122 closed upon receiving a command from the controller 106. An “actuate closed” command can be sent from the controller 106 when the top-oriented sensor 110 detects an interface level low level indication or when a set time delay has timed out, for example, triggering an automatic sequence (referred to in FIGS. 3 and 4) from the controller 106 that closes the valve 122. The current system and techniques are not limited to only the events described as indicators for when to automatically open and close the valve 122. Several types of sensors and controllers are known to those having skill in the pertinent art, and can be implemented.

In accordance with exemplary embodiments of the current system and method, when an “actuate open” and “actuate closed” cycle is complete a measureable amount of fluid 126 will have evacuated the storage vessel 112. The current system and method ensures the dumped fluid 126 will be of an easily measurable quantity because of the timed delay latching block sequence in the logic of the controller 106. Fluid 5 flow rates can be measured utilizing devices such as turbine meters, magnetic flow meters, or orifice meters, among others, This sequence initiates when an electrical signal has been sent to the actuator 120 that drives the motor to completely open the valve 122. The sequence closes and resets when either an interface level low level indication is detected, or an indication that the sequence has timed out was processed by the controller 106. This operation ensures a more easily measured volume of evacuated fluid 126 because it tends to avoid a trickle flow through the valve 122, which may be more difficult to measure.

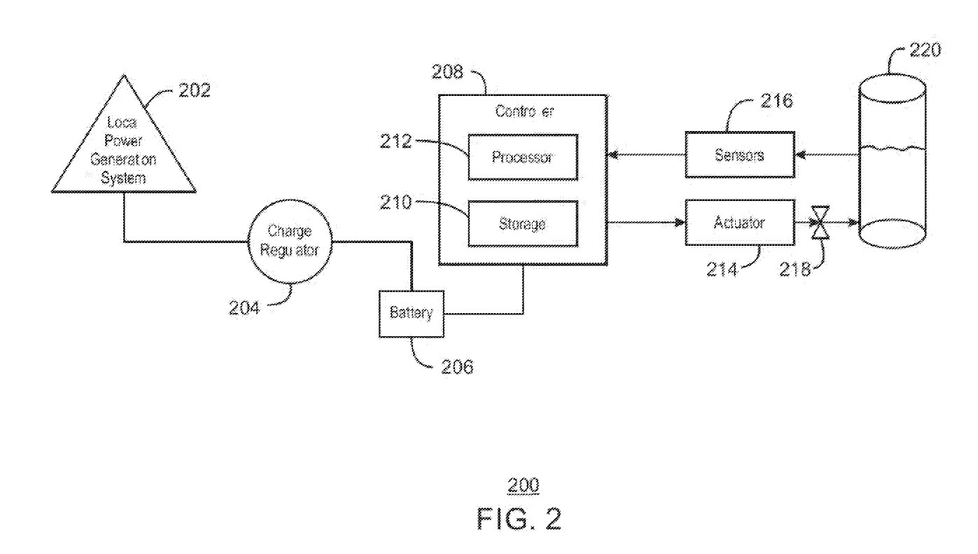

FIG. 2 is a schematic of an automatically controlled actuator system 200 that is powered by a local power generation system 202. An exemplary embodiment of the present technique utilizes photovoltaic solar modules to energize the automatically controlled actuator system 200. Other examples of local power generation systems can include wind turbines, thermionic generators, fuel cells, and electric generators, among others. The locally generated power can be produced from hydrocarbons produced, for example, from a local well. The voltage produced from the local power generation system 202 is sent to a charge regulator 204 that regulates the electricity received to the designed voltage level for a battery 206.

The battery 206 is used to store the electric energy until it is used by the system components, including the sensors 216, actuator 214 and controller 208. The controller 208 can include a storage component 210 for storing data. In exemplary embodiments, the storage component 210 can be a programmed device such as read only memory (ROM), electrically erasable, programmable ROM (EEPROM), erasable, programmable ROM (EPROM), programmable ROM (PROM), or an application-specific integrated circuit (ASIC), which are well known in the industry, and can include other non-volatile memory, such as battery-backed-up RAM, or any other electronic, optical, magnetic, or other storage capable of providing a processor or processing unit with computer-readable instructions. The controller 208 also includes a processor 212 to run and evaluate stored programs, access system memory and respond to sensor 216 inputs, among other tasks.

Examples of a controller 208 that can implement the current technique include programmable logic controllers, simple feedback controllers such as an on-off controller, proportional controllers, proportional-integral controllers and proportional-integral-derivative controllers, which are all well known in the pertinent art. Other examples of implementable controllers include microcontrollers that are self-contained systems processor, memory and peripherals. Such a microcontroller can be embedded into the current system and dedicated to handle a particular task, for example, to monitor interface levels within a vessel system and drive a motor to open and close a valve when those interface levels are indicated at certain set points.

The controller 208 sends electrical signals to the actuator 214 based in part on when the sensors 216 detect a specific event and send an indication back to controller 208. In exemplary embodiments, the sensors 216 are configured to detect an interface level of a fluid within a vessel 220. The sensors 216 for detecting the interface level within the vessel 220 can be, but are not limited to, magnetic limit switches, microswitches, or sensor switches that directly respond to physical contact. In other embodiments, the sensor 216 can be an ultrasonic point level device, an optical interface detector, or a continuous level monitoring device, or a combination thereof. When the interface level of the fluid within the vessel 220 is detected sufficiently high, a high level indication is communicated by the sensors 216 to controller 208. Conversely, when a low level is detected by the sensors 216 a signal is again sent to the logic controller 208, Controller 208 is configured to then send a voltage to the actuator 214 to completely open a valve 218 connected to the vessel or tank system 220.

The valve 218 could be any valve typically used in industry, including but not limited to globe valves, ball valves, gate valves, pinch valves, butterfly valves, check valves, etc. The automatically controlled, locally powered actuator system 200 of the current invention can be retrofitted in order to fit an existing valve 218 without modifying the existing valve 218. In an embodiment, an actuator bracket attaches an actuator 214 to a valve 218 already in operation. By removing the linkage from the float in the tank to the valve arm and attaching instead the system's linear motor arm to the valve arm, actuation of the valve is achieved. An exemplary embodiment includes attaching a linear motor to the actuator bracket, which is attached to the valve body itself by utilizing existing threaded bolts in the valve body. The linear motor can be adjusted up or down the bracket to ensure the valve fully closes. In further embodiments, the controller 208 is housed nearby the actuator 214 that has been attached to a valve 218, and the local power generation system 202 can be connected to the controller 208 and actuator 214.

FIG. 3 is a schematic of how controller logic sequence 300 processes commands sent by the controller based on input signals that are received. When a high level input 302 is received, the logic sequence begins and latching block 304 is latched and latching block 314 is unlatched. Delay-on block 306 is activated for a set amount of time, for example 2 seconds. After the set amount of time, relays 308 and 310 are activated, which provide for a positive to negative voltage and current flow to the actuator, for example 12 VDC +/−, This signal engages the actuator to move the valve to the completely open position.

In an exemplary embodiment, the logic controller employs a Boolean logic program so that when a high level is detected it closes two relay contacts to send a current across the motor to open the valve. When the low level is detected the two other relay contacts close to send current to the motor. Reversing the polarity on the motor reverses the direction of movement. A linear motor can be utilized that has built in limit switches so the when the valve reaches the fully open position or fully closed position the circuit is opened so that no power is being used except during actuation.

When a low level input 312 is received, latching block 314 is latched and latching block 304 is unlatched. Delay-on block 316 is activated for a set amount of time, for example 2 seconds. After the set amount of time, relays 318 and 320 are activated, which provide for a negative to positive voltage and current flow to the actuator, for example 12 VDC −/+. This signal engages the actuator to move the valve to the completely closed position. The logic sequence 300 proceeds by waiting for another high level input 302 to be indicated, and the process described is initiated once more.

FIG. 4 is a process flow diagram of a method 400 for monitoring an interface level and automatically actuating a valve completely open or closed. The method 400 starts at block 402 with the monitoring of the interface level within a tank storage system. A determination is made at decision node 404 whether the interface level is indicating the set point high level alarm. If no such high level indication is being detected, then the process continues at block 402 with monitoring the interface level in the tank storage system again. If a high level indication has been detected, then a signal will be sent the actuator and at block 406 the dump valve connected to the tank storage system is completely opened.

At block 408, a timed delay latching block sequence is activated by the logic controller. The timed delay is held open or on for a set time, or until a low level event has been detected. A determination is made at decision node 410 whether the interface level is indicating a set point low level alarm. If such a low level indication is being detected, then block 416 calls for the actuator to be signaled to actuate the valve closed. If no low level indication is detected, then another decision is made at node 412 as to whether the timed delay latching block sequence has timed out. If so, then the dump valve will be completely closed at block 416. However, if there has been no low level set point indication and the timed delay latching block sequence has not timed out, then at block 414 an “actuate open” signal will continue to be sent to the dump valve actuator, and the process continues to cycle through to decision node 410 once more.

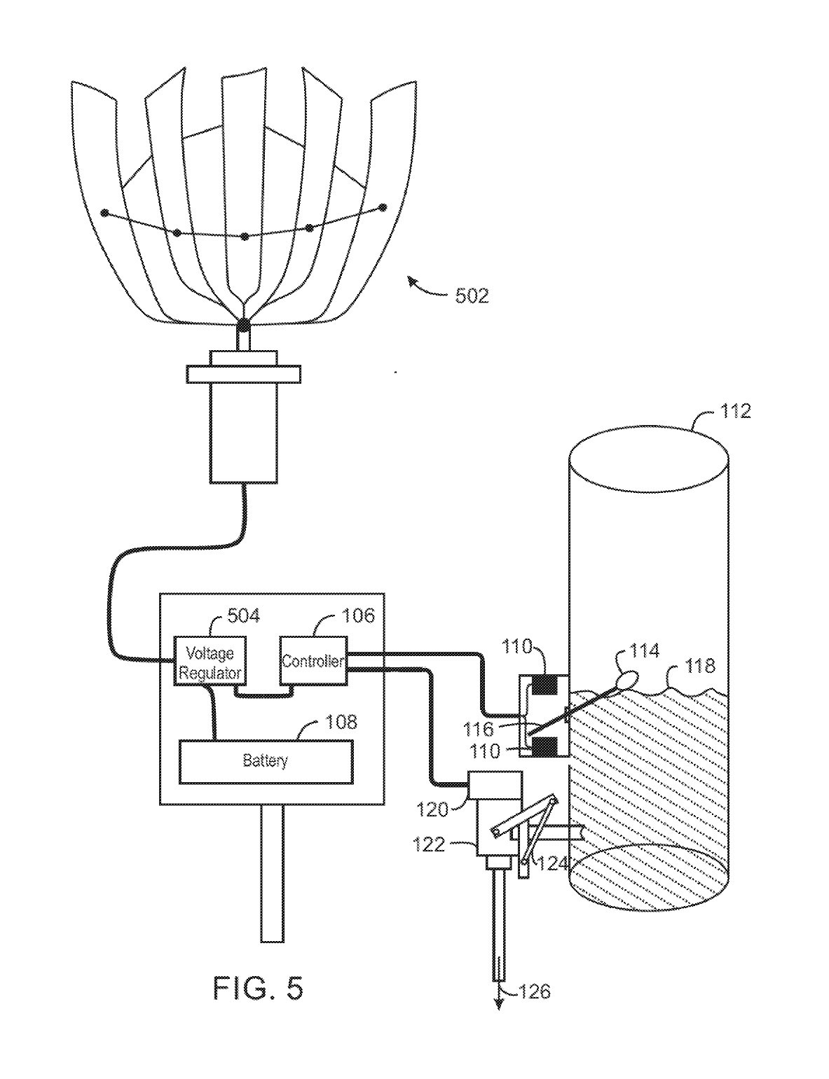

FIG. 5 is another schematic of an actuator system that is automatically controlled and powered by a local power generation system, where the power is generated by a wind turbine 502. This schematic will include a voltage regulator 504 different from those used in conjunction with other local power generating systems, such as a solar panel or a fuel cell, for instance. For the rest of FIG. 5, like numbered items are described in the same manner provided in the description for FIG. 1, supra.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

What is claimed is:

1. A system for automatically actuating a valve, comprising:
a local power generation system;
a controller connected to a sensor, an actuator and the local power generation system:
wherein the sensor, controller and actuator are powered by the local power generation system, wherein:
the sensor is configured to detect an interface level within a vessel and communicate the interface level to the controller;
the controller is configured to send a signal to the actuator based on the interface level; and
the actuator is configured to completely open a valve when the signal is received.

2. The system of claim 1, wherein the local power generation system comprises a SC of photovoltaic solar modules.

3. The system of claim 1, wherein the local power generation system comprises a wind turbine, a fuel cell, or a thermionic generator.

4. The system of claim 1, wherein the interface level that is being detected within the vessel comprises an oil/water interface.

5. The system of claim 1, wherein the local power generation system is connected to a voltage regulator and charges a battery.

6. The system of claim 1, wherein the controller runs a control sequence, and the control sequence incorporates a timed delay latching block that is activated after the actuator receives a command to open the valve, wherein the timed delay latching block is activated for a set amount of time before the controller is configured to automatically send a command for the actuator to close the valve.

7. The system of claim 1, wherein the valve is an existing valve.

8. The system of claim 1, wherein the valve is actuated completely open by the actuator when the interface level is detected at a high level set point, and the valve is actuated closed by the actuator when the interface level is detected at a low level set point.

9. The system of claim 8, further comprising a timed delay latching block sequence in the controller that initiates when the valve is actuated completely open, and automatically sends a signal for the actuator to close the valve after a set delay has timed out.

10. The system of claim 1, wherein the sensor for detecting the interface level within the vessel is comprised of a set of magnetic limit switches.

11. The system of claim 10, wherein a float and rod assembly is connected to the vessel and the set of magnetic switches are connected to a valve bracket, and when the float rises an external arm of the float and rod assembly travels downward and when the float sinks the external arm travels upward, and when the external arm travels within a sensing area of one of the set of magnetic switches a corresponding signal is sent to the controller which commands the actuator to actuate the valve open or closed.

12. The system of claim 1, further comprising a measuring device connected downstream of the valve, wherein the measuring device is used to measure the volume of fluid dumped by the vessel.

13. A method for automatically controlling the actuation of a valve, comprising:
monitoring an interface level within a vessel;
detecting a first event;
signaling an actuator to actuate completely open a valve when the first event is detected;
activating a timed delay latching block sequence after the valve has been actuated completely open;
detecting a second event; and
signaling the actuator to actuate closed the valve when the second event is detected.

14. The automatic method of claim 13, wherein the first event that is detected comprises an interface level high level indication.

15. The automatic method of claim 13, wherein the second event that is detected comprises either an interface level low level indication, or an indication that the timed delay latching block sequence has timed out.

16. The automatic method of claim 13, wherein the steps of monitoring the interface level, detecting the first and second events, signaling the actuator, actuating the actuator, and activating a timed delay latching block sequence are energized by a local power generation system.

17. The automatic method of claim 16 wherein the local power generation system comprises a set of photovoltaic solar modules.

18. A non-transitory, computer-readable medium, comprising code to configure a processor to detect a first signal from a sensor, wherein an actuator is then directed to open a valve, and the valve remains open until a second signal is indicated, wherein the actuator is then directed to close the valve.

19. The non-transitory, computer-readable medium of claim 18, wherein the first signal detected by a sensor is a high level indication of an interface level within a vessel.

20. The non-transitory, computer-readable medium of claim 18, wherein the second signal is a low level indication of an interface level within a vessel, or the second signal is an indication that a timed delay latching block sequence has timed out.
